(19) United States
(12) Patent Application Publication
(10) Pub. No.: US 2020/0016446 A1
(43) Pub. Date: Jan. 16, 2020

(54) SYSTEM FOR FASTENING OBJECTS

(71) Applicant: Wonder GmbH, Eggenfelden (DE)

(72) Inventor: Helmut SPECKMAIER, Eggenfelden (DE)

(73) Assignee: Wonder GmbH, Eggenfelden (DE)

(21) Appl. No.: 16/481,059

(22) PCT Filed: Jan. 30, 2018
(86) PCT No.: PCT/EP2018/052314

§ 371 Date: Jul. 25, 2019

(30) Foreign Application Priority Data
Feb. 1, 2017 (DE) 20 2017 100 548.8
Nov. 23, 2017 (DE) 20 2017 107 099.9

(51) Int. Cl. A63B 21/055; A63B 21/16

(52) U.S. Cl. CPC A63B 21/0557; F16M 11/041; A63B 2225/09; A63B 21/169

(57) ABSTRACT

The invention relates to a system for fastening objects, comprising an, especially, planar holder, and at least one fastening device, wherein the fastening device is connected or can be connected to the holder via a slotted guide and is configured for continuously variable, detachable fastening to the holder, wherein the slotted guide is configured in such a way that the fastening device can be adjusted in at least two dimensions relative to the holder.

The invention relates to a system for fastening objects, comprising a holder and at least one fastening device.

In fitness studios, for example, there are various items of sports equipment that together form a stretching circuit system. The sports apparatus is distributed throughout a room and therefore takes up a great deal of space. The walls, on the other hand, remain unused and bare.

It is well known that various items of sports equipment can be fastened to a wall. For this, a panel-shaped holder is fastened to the wall. The holder comprises several spaced recesses for inserting fastening devices, to which, in turn, sports equipment is fastened. This system is relatively inflexible, as the fastening devices can only be inserted into the recesses and so cannot occupy any intermediate positions.

Variable adjustment is not possible. In particular, the height of the sports equipment can only be adjusted in increments that match the grid.

Slotted guides are known, whereby a sliding block engages with a groove. If the sliding block is not fastened, it can slide along the groove, perhaps unintentionally. It is known that the sliding block can be screwed tightly at the groove. Fastening and loosening of the sliding block, however, require a certain amount of time.

It is therefore one of the objects of the invention to improve a system for fastening objects of the type mentioned above in such a way that variable fastening of objects is possible.

This object is achieved by the system having the features of claim 1.

In accordance with the invention, the fastening device is connected or can be connected to the holder via a slotted guide and is configured for continuously variable, detachable fastening to the holder.

The slotted guide can have a groove and a sliding block. For example, the sliding block can be brought into engagement with the groove and adjusted relative to the groove. Preferably, the holder has the groove and the fastening device has the sliding block. Alternatively, the fastening device too can have a groove, which is brought into engagement with a sliding block of the holder. In this regard, the groove or the sliding block of the holder can be configured as a type of rail.

The groove or the sliding block of the holder and/or the sliding block or the groove of the fastening device can have toothing and/or a friction-enhanced material. Thus, the fastening device is prevented from slipping unintentionally, for example where the groove or sliding block follows a vertical route.

The slotted guide is configured in such a way that the fastening device can be adjusted in at least two dimensions relative to the holder.

In particular, the adjustability exists only when the fastening device is in a loosened adjustment position. If the fastening device is fastened in the holder, no adjustment is possible.

In the adjustment position, the fastening device can thus be moved in the slotted guide relative to the holder. The dimensions can, in particular, be an x- and a y- direction. Thus, it is also possible, for example, to make height adjustments. Consequently, an object can be continuously adjusted to a certain height, for example to suit the size of a user.

Alternatively or additionally, the two-dimensional movement can also comprise other directions in a plane, for example an oblique movement.

When the fastening device is being fastened, it is preferably fastened simultaneously in two dimensions, i.e. no movement is now possible in any direction. Accordingly, when the fastening device is loosened, adjustability in two dimensions is preferably achieved. The same fastening mechanism thus enables or prevents adjustment in all directions of the plane.

Preferably, the fastening device can be fastened to the holder without tools. The position of the fastening device on the holder can thus be changed quickly and easily.

Especially, the holder is planar. For example, the holder can be panel-shaped. For example, the holder can define a plane in which the fastening device can be adjusted and continuously fastened.

Objects can be fastened variably in this way. Also, previously unused walls of a fitness studio can be used.

Further embodiments of the invention can also be found in the dependent claims, the description and the attached drawings.

According to one embodiment, the slotted guide is configured in such a way that the fastening device can be adjusted in at least one vertical direction and at least one horizontal direction.

The horizontal direction is, in particular, at right angles to the vertical direction. Preferably, adjustment in the x- and y-directions is possible.

In particular, the slotted guide comprises at least one, preferably several, vertical and horizontal guides. The directions in which the fastening device can be adjusted are determined by the guides. For example, several vertical and horizontal guides can be disposed in a grid and have points of intersection.

According to a further embodiment, the slotted guide is configured in such a way that the fastening device can be adjusted in at lease one oblique direction. The fastening device can, for example, be adjusted obliquely, and especially diagonally. The slotted guide can, for example, comprise one or more oblique guides, and especially diagonal guides. The guides can also be disposed in a diamond shape. For example, several oblique guides can be disposed in a grid and have points of intersection.

According to a further embodiment, the slotted guide is configured in such a way that the fastening device can be adjusted in at least one curved trajectory. The fastening device can, for example, be adjusted circularly and/or arcuately, and especially in the form of a circular segment. Thus, the slotted guide can, for example, comprise one or more circular and/or arcuate guides, in particular circular segment guide(s).

In particular, several arcuate guides may be disposed one above the other. In this regard, for example, a degree scale can be provided. A user can select a particular curved guide to match his size and measure his mobility or improvement in mobility. For this, the user stands centrally beneath the arch and bends his upper body to the side, preferably with outstretched arms. The fastening device can serve as a marker for the maximum lateral deflection, for example as a target to be reached or as a marker of the deflection achieved.

Preferably, horizontal, vertical, oblique and curved slotted guides can be combined with one another. This further increases the fastening and application possibilities.

According to a further embodiment, the slotted guide has at least one insertion/removal section into and/or from which the fastening device can be inserted and/or removed.

Preferably, the opening of the groove at the insertion/removal section can be larger than the sliding block.

In particular, several insertion/removal sections can be provided, such that the fastening device can be inserted or removed at different points. In particular, however, insertion or removal is not possible everywhere, i.e. beyond the insertion/removal sections, the fastening device can only be moved, because there the opening of the groove is smaller than the sliding block. Insertion and removal are only possible at certain sections. The insertion/removal sections can basically be provided at any position.

According to a further embodiment, the holder comprises grooves and/or sliding blocks, which especially are disposed in a grid pattern. The grooves or sliding blocks can be configured as square or rectangular grids. A diamond-shaped grid is also possible.

The side length of a grid segment can in particular be between 10 cm and 50 cm, in particular 15 cm, 20 cm or 30 cm. The smaller the side length, the more versatile is the system.

The grooves and/or sliding blocks of adjacent grid segments can in particular be connected to each other or configured as a unit. This gives rise to a rail system consisting of grooves and sliding blocks.

The grooves and/or sliding blocks of the holder determine the direction in which the fastening device moves. Insertion/removal sections can preferably be provided at points of intersection of the grooves and/or the sliding blocks. In particular, each point of intersection can have an insertion/removal section.

According to a further embodiment, the grooves are T-shaped or dovetail-shaped. These shapes provide a good hold.

The grooves of the holder may be slightly recessed from the surface, for example by between 0.1 cm and 1 cm, preferably 0.2 cm. This improves the tautness in the fastened state. The fastening device will also hold if the material of the holder, for example wood, becomes deformed.

According to a further embodiment, the groove has at least one recess for a projection member. In particular, several recesses can be provided, for example at equal intervals. The projection member can snap into the recess. In this way, the fastening device is additionally fastened.

According to a further embodiment, the holder is panel-shaped. Preferably, a groove can be made in the panel, for example by milling, or a sliding block can be formed on the panel.

The panel can in particular be a multiplex panel, plastic panel, screen printing panel and/or wooden panel. The grooves or sliding blocks can be formed directly from the material of the panel, for example by milling. Alternatively, the grooves or sliding blocks can also be moulded subsequently, for example from another material such as plastic or metal. The grooves or sliding blocks, too, can be provided with a different material. For example, a metal rail can be inserted into a groove or the metal rail itself can form the groove.

The holder can be configured as a wall holder, column holder, ceiling holder or floor holder.

Thus, the holder can be fastened in a simple manner to existing structures. Larger surfaces such as walls, ceilings and floors as well as smaller surfaces such as columns can be provided with a holder. Existing obliques or new obliques, too, can be provided, depending on the area of application. An entire column can be provided with a holder. Alternatively, the holder can also be fastened to just one, two or three sides of the column.

The holder can also be used without a pre-existing structure. For example, the holder can be configured as a free-standing box, wall or tower. A free-standing wall can have a slotted guide on one or both sides. In particular, a tower can have two, three or four sides, which can have slotted guides as required.

The holder can also comprise several panel-shaped tiles. In particular, the tiles can be disposed one beside the other. The edges of the tiles can be shaped, e.g. angled inwards, so that the joint between two adjacent tiles forms a groove.

Such tiles can be provided on larger or smaller areas as befits requirements. In this regard, several tiles can be placed next to each other in a modular way.

The tiles can be used in bathrooms, for example, to attach a towel or toilet paper holder. In contrast to conventional, permanently mounted holders, they can also be moved to a different position at a later date.

The tiles can also be used in kitchens, for example. In particular, the entire tiled backsplash can be fitted with the functional tiles in order, for example, that a spice rack may be fastened to them or in the groove between the tiles. If the tiles are disposed on the underside of a shelf or on the ceiling, various utensils can also be hung in at the top. For example, spoons, scrapers, turners, ladles and the like can be hung directly into the groove if the handle is shaped accordingly.

The tiles can be made in particular of wood, metal and/or plastic, e.g. Corian® and the like.

The material can be chosen to suit the load to be borne. During production from a block of material, the tiles can already be given angled edges.

If the tiles are made of a metal material, fastening tabs can be formed and bent, for example, in order that the tiles may subsequently be fastened, e.g. to a wall or ceiling.

As an alternative to a panel-shaped holder, grooves or sliding blocks can also be plastered directly into a wall. For example, sheet metal as a groove can be concreted into formwork.

Such grooves or sliding blocks disposed in two dimensions also form a holder in the sense of the invention.

According to a further embodiment, the holder is modular and comprises several panels that can be disposed next to each other. As required, several holder modules can be combined with each other and disposed next to each other, e.g. laterally or one above the other. This allows the length, height and/or width of the holder to be subsequently extended, too.

According to a further embodiment, the holder can be fastened to a wall, ceiling and/or floor.

The holder is therefore preferably not free-standing. Previously unused structures can thus be used, with only little additional space being required.

Preferably, a batten can be mounted first on the wall, ceiling and/or floor, for example with the aid of dowels. The holder can then be hung into the batten. The holder can have an undercut by way of fastening means, which is brought into engagement with the batten. The holder is thus flush, saving space. The holder can, for example, be additionally screwed to the batten.

Alternatively, the holder can also be mounted directly to the wall, ceiling and/or floor, e.g. screwed tightly to it.

According to a further embodiment, the fastening device comprises an elongated or round sliding block.

An elongated sliding block can have a length of between 5 cm and 15 cm, preferably 10 cm.

The maximum width, for example, can be between 1 cm and 2 cm, preferably 1.5 cm.

The width of an elongated sliding block or the diameter of a round sliding block is preferably smaller than the maximum diameter of the groove and larger than the minimum diameter of the groove. In particular, the round sliding block can be firmly clamped, for example, to a groove configured as a metal rail.

The groove and/or the sliding block can have toothing and/or a friction-enhanced material. The groove or the sliding block can have knurling, transverse, longitudinal and/or diagonal grooves.

As a result, unintentional slipping is prevented.

According to a further embodiment, the sliding block is T-shaped or dovetail-shaped. In particular, the sliding block corresponds to the shape of the groove. This guarantees secure guidance and secure hold.

According to a further embodiment, the fastening device comprises a screwing, locking and/or clamping device for the purpose of fastening to the holder. The fastening device can preferably be fastened to the holder without tools, in particular to a groove in the holder.

In particular, the screw device can comprise a star grip screw, with which fastening can be achieved simply. A click system is also conceivable. Thus, for example, the fastening device can be fastened by turning through 90 degrees.

Furthermore, the underside of the fastening device can have a spring member, in particular a spring plate. Thus, the fastening device can always be firmly clamped and held in the holder without being screwed tight. For a secure hold, however, a screw connection, for example, can be used additionally.

The pre-tensioned spring member prevents the fastening device from slipping out of the vertical plane unintentionally, for example. The fastening device is adjusted by exerting a force against the pre-tensioning force of the spring member.

According to a further embodiment, the fastening device comprises a sliding block which has at least one overhang.

In particular, an overhang is defined as a, preferably symmetrical, projection with an undercut.

The overhang can be brought into engagement with a groove, as a result of which the sliding block is positively guided in the groove.

The fastening device comprises a projection device, wherein the projection device has a projection member which is adjustable between a fastening position and a displacement position, wherein at least a portion of the projection member in the fastening position projects further over the end-face of the sliding block than in the displacement position.

In particular, the end-face of the sliding block can be round, oval or angular, preferably rectangular, for example square, or polygonal. For example, an elongated, in particular oval, sliding block can be braced by twisting into a groove.

The sliding block, and especially the end-face of the sliding block, can have toothing and/or a friction-enhanced material, especially a rubber material.

In the fastening position, the sliding block is extended to some extent forwards and beyond the end-face, by the projection member. The projection member is preferably disposed centrally or decentrally. It is also possible for several projection members to be provided.

In particular, the sliding block can also have lateral projection members, so that a projection member is provided not just at the end-face. For example, in the case of a square sliding block, a lateral projection member can be disposed on each side.

In the fastening position, the projection member is extended. The sliding block pushes away to some extent from the rear side of the slotted guide, such that the fastening device wedges itself against the slotted guide. The fastening device is self-locking.

To additionally secure the fastening device, the fastening device can have a screwing, locking and/or clamping device. However, this is not necessary. The fastening device is already fastened by the projection device.

In the displacement position, on the other hand, the fastening device can be displaced in the groove. The projection member can, for example, be pushed in by the application of force. The sliding block then has play to be moved freely in the groove.

In particular, no tools are required to actuate the projection device. Rapid fastening is thus made possible.

In the region of the end-face, for example, the sliding block can have a rigid projection or a structure. Given an appropriately shaped groove, this ensures that only certain sliding blocks can be brought into engagement with the groove or sections of the groove. Thus, a sliding block of a certain structure can, for example, only penetrate into an appropriately shaped groove, thereby avoiding misplacements, mix-ups and/or incorrect assembly.

According to an embodiment, the projection device has a pre-tensioning device which pre-tensions the projection member into the fastening position. Thus, in the absence of application of force, the projection member is in the extended position and the fastening device is secured.

According to a further embodiment, the pre-tensioning device has an elastic member. In particular, this can be a spring or an elastomer. For example, a silicone material or a gel-like compound can be provided. The elastomer can, for example, be configured as a hinge or damper.

According to a further embodiment, at least sections of the pre-tensioning device are disposed inside the sliding block. In particular, the pre-tensioning device does not protrude beyond the end-face side of the sliding block in the displacement position, with the result that the sliding block can be easily displaced.

According to a further embodiment, the projection member in the displacement position is at least partially countersunk in the sliding block. The projection member preferably does not project beyond the end-face of the sliding block, with the result that the sliding block can be moved without any problems.

According to a further embodiment, the projection member is configured as a ball, cone, cube or pin. In the fastening position, for example, about half of a ball can project beyond the end-face of the sliding block.

According to a further embodiment, the fastening device has a stop body with a stop surface, whereby the sliding block protrudes beyond the stop surface.

The stop body and the sliding block can preferably be formed in one piece.

The sliding block can protrude in particular at right angles or obliquely to the stop surface, in particular towards the front.

The stop surface can, especially in the fastening position, strike against the groove guide, preferably an outer edge of the groove guide. The groove guide is located between the stop surface and the overhang. In the fastening position, the fastening device becomes clamped to a certain extent at the edge of the groove guide.

Preferably the stop surface is larger than the sliding block. This improves self-locking. In principle, however, the stop surface can also be smaller than the sliding block.

The stop surface can, for example, be round, oval or angular, preferably rectangular, e.g. square, or polygonal. A round stop surface in particular acts quickly at the groove guide. The orientation, too, is irrelevant.

According to a further embodiment, the stop body has lateral projections, e.g. for locking. In particular, these can be elevated. The projections can also project over the stop surface in particular. This gives rise to early contact with the groove guide during fastening.

According to a further embodiment, the stop body has a holding device for an object, especially on its side facing away from the stop surface. An object can thus be connected to a groove via the holding device on the fastening device and via the fastening device.

The object can, for example, be a shelf element, e.g. a shelf or a shelf wall, or a room divider.

The fastening device is therefore suitable, e.g., for shop fitting.

In addition, sports equipment or tools can also be fastened to the fastening device.

In particular, the object itself can have the fastening device and, for example, form a unit.

According to a further embodiment, the holding device has a retaining pin, especially with an external thread. An object can be fastened, for example, to the retaining pin, e.g. screwed onto it.

The retaining pin can, for example, be fastened into a recess in the stop body, e.g. screwed in.

In particular, the retaining pin can have a tool holder at one end, preferably an internal polygon socket, e.g. an internal hexagon socket, or an internal round socket, e.g. a hexalobular internal socket. The retaining pin can be fastened to the stop body via the tool holder.

According to a further embodiment, the holding device has an undercut. For example, an object can be fastened to the holding device and rotated. The undercut prevents unintentional loosening, in a manner comparable to a bayonet lock.

In principle, the holding device can be any suspension, hook and loop, adhesive, clasping, clamping, plug-in, locking, magnetic, tenon and/or screw device. In particular, fastening can proceed without tools.

An object can thus be fastened to the holding device in a simple manner, especially in a detachable manner. Quick replacement is thus guaranteed.

According to a further embodiment, the holding device has at least one holding slot. In particular, the holding slot can extend across the end-face facing away from the stop surface.

In particular, several, in particular two, e.g. intersecting holding slots are possible.

The holding slot can also extend between the upper end-face and the stop surface, for example as a lateral slot. Several holding slots can also be provided there.

The holding slot can basically have an arbitrary shape. For example, the holding slot can have straight walls or be U-shaped or V-shaped. Alternatively, it can also be configured as a groove, e.g. dovetail or cone-shaped or as a T-slot.

The holding slot, too, can have an undercut.

According to a further embodiment, the holding device has a safety element, in particular a screw. An object inserted into, e.g., a holding slot can thus be fastened and/or locked. The screw can especially be a grub screw.

According to a further embodiment, the sliding block and/or a stop body has a recess, especially a central recess, for the projection device. The recess can in particular be cylindrical.

A projection member, for example a ball, and a pre-tensioning device, e.g. a spiral spring, can be inserted into the recess. The recess can then be locked with, e.g. a retaining pin.

According to a further embodiment, the recess tapers at least in the region of the end-face of the sliding block. In particular, this prevents the projection member in the region of the end-face from unintentionally exiting the recess.

According to a further embodiment, the diameter of the recess in the region of the end-face of the sliding block is smaller than the diameter of the projection member. In particular, this prevents the projection member in the region of the end-face from unintentionally exiting the recess.

According to a further embodiment, the recess has an internal thread. For example, a retaining pin can be fastened in the recess. The retaining pin can thus fulfil a double function. On the one hand, it can pre-tension the pre-tensioning device or adjust the strength of the pre-tension.

On the other hand, it can serve as a holder for an object.

According to a further embodiment, the sliding block has a T- or V-shaped cross-section. The sliding block, too, can be dovetailed or conical in shape.

A conical sliding block, for example, is independent of the orientation of the groove. It can be moved in the x- or y-direction as well as diagonally. The number of degrees does not matter.

The sliding block widens, especially starting from the stop surface. As a result, the overhang forms which holds the sliding block in the groove.

According to a further embodiment, the sliding block has at least three, four, five, six, seven or eight side-faces, and in particular funnel-shaped side-faces, extending from a stop surface of a stop body. Preferably four or eight side-faces are provided. In the case of four side-faces, the sliding block can be moved, e.g., in two dimensions, in particular horizontally and vertically. In the case of eight side-faces, in particular displacement of 45 degrees would be possible in addition.

According to a further embodiment, the side-faces and/or the corner lines of the side-faces extend at the same angle from a stop surface of a stop body. The angle can be, e.g., 90 degrees. The side-faces in that event extend at right angles to the stop surface. Alternatively, the side-faces may also be disposed obliquely, for example at an angle of less than 90 degrees. Thus, the angle can be between, for example, 60 degrees and 80 degrees, preferably 75 degrees.

According to a further embodiment, at least two side-faces and/or at least two corner lines of the side-faces extend at different angles from a stop surface of a stop body.

In the case of four side-faces, for example, the sliding block can be straight on both sides or on one side and, in particular, form a shoe. In this way, static loads can be easily absorbed.

The invention also concerns a system for fastening objects, comprising a holder, in particular a planar holder.

According to a further embodiment, the fastening device comprises a holding device for an object, in particular an item of sports equipment and/or a medical device. Via the holding device, an object can be fastened to the fastening device and thus to the holder.

The object can, for example, be a wall bar. This can be oriented parallel with or at right angles to the wall. In the case of at right-angled orientation, a support to counteract torsional forces can be provided on the far side from the wall. The support can, for example, be anchored to the floor.

The object can also be a ladder, for example a rope ladder, a net, a slide, a pulley, e.g. a fascia pulley, or a rope, e.g. a skipping rope, SDX® Rope, aeroSling® or an expander.

The object can also be configured as a vertically adjustable basketball basket, a goal, a bar, for example a pull-up bar or a dip bar, a punch bag, a punch ball or as an element of a stretching circuit system.

Furthermore, the object can be a dumbbell. For example, a barbell can be hinged to the fastening device on the wall side, while the side remote from the wall is weighted.

The object can also be a pulley, a hook, an express set or a climbing grip.

Furthermore, the object can be configured as a storage device, in particular for a towel, a rope, a weight, for example a dumbbell or barbell bar, a ball, e.g. Bosu®.

In addition to sports equipment, medical equipment is also conceivable. For example, the object can be a device for measuring body size. It can also be a device for measuring and/or improving mobility. Such a device can be fastened as a separate component. Alternatively, a fastening device can also be adjusted to act as a marking into a curved slotted guide. The device for measuring and/or improving mobility can in this regard comprise a degree scale for determining upper-body deflection.

The object is not limited to sports or medical equipment. For example, the object can be an illuminating fixture, a cabinet segment, a shelf, a picture, a television set, a coat hook, a wardrobe or a tool wall. Kitchen, bathroom and/or toilet utensils, too, can be fastened. For example, a bathroom or a toilet for the disabled can be equipped with an inventive system.

Handles and the like can be easily mounted and/or adapted to the respective requirements.

Depending on the size and/or weight of the object, several fastening devices can be fastened to the holder at the same time as well. In this way, the load of the object can be distributed across several fastening devices.

According to a further embodiment, a marking is provided to indicate a fastening point for the fastening device. Depending on the object to be fixed or on the user, the marking indicates an optimum height or position for the fastening device. The marking can also be, e.g., a degree scale for a device that measures and/or improves mobility. The markings may comprise alphanumeric characters, symbols and/or colours.

For example, markings can be used to specify different fastening points for climbing grips.

Different climbing routes, especially with different degrees of difficulty, can be easily built in this way.

The panel-shaped holder can be provided with a friction-enhanced material, e.g. to provide a better grip when climbing.

The panel-shaped holder can also be printed, coated and/or painted. Thus, the appearance, for example, can be improved. The holder can also be used as advertising space.

The fastening system can especially be provided in a container. For example, the walls, ceiling and/or floor of a container can be equipped with a fastening system as per the invention.

The invention thus also concerns a container with preferably an inventive system for fastening objects, comprising a holder, in particular a planar holder, and at least one fastening device.

The fastening device is connected or can be connected to the holder via a slotted guide and is configured for continuously variable, detachable attachment to the holder. The slotted guide is configured in such a way that the fastening device can be adjusted in at least two dimensions relative to the holder.

The container can, for example, be an ISO container or swap body. An ISO container is a standardised sea freight container. A swap body is suitable for transport on a truck.

For example, such containers can be set up as temporary fitness centres, e.g. at festivals. Such containers can also be used, e.g., as compact apartments.

For the combination of a container with a fastening system as per the invention, protection is also sought regardless of the design of the fastening device.

The invention also concerns a temporary structure with preferably an inventive system for fastening objects, comprising a holder, in particular a planar holder, and at least one fastening device. The fastening device is connected or can be connected to the holder via a slotted guide and is configured for continuously variable, detachable attachment to the holder. The slotted guide is configured in such a way that the fastening device can be adjusted in at least two dimensions relative to the holder.

The fastening system can therefore be used in a temporary structure, for example. Thus, the walls, ceiling and/or floor of a temporary structure can be equipped with a fastening system as per the invention.

A temporary structure is in particular a structure configured to be repeatedly erected and/or dismantled.

For example, this can involve fairground rides, (show) stalls, grandstands, stages, amusement rides, tents and/or temporarily stationary wagons.

For the combination of a temporary structure and a fastening system as per the invention, protection is also sought regardless of the design of the fastening device.

All the aspects, embodiments and features of the invention described here, and especially also independently of the specific embodiment in the context in which they are mentioned, can be combined with each other. In particular, all objects of the dependent claims can be combined with each other and with the object of the independent claim.

In the following, the invention is described by way of example with reference to the drawings.

These show in

FIG. 1 a front view of an embodiment of a fastening system as per the invention,

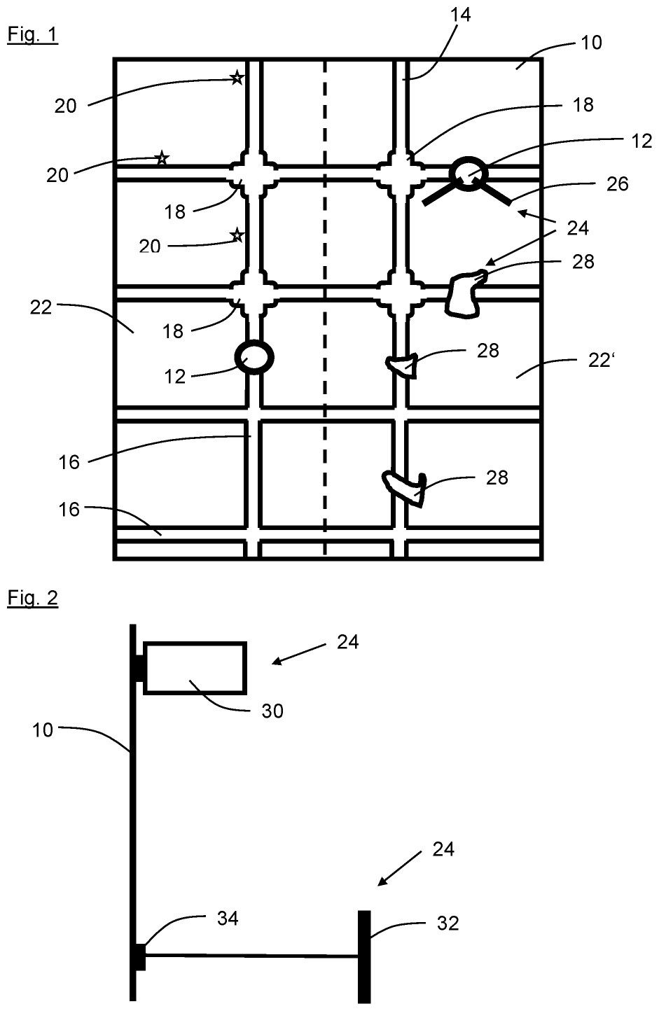

FIG. 2 a side view of a further embodiment of a fastening system as per the invention,

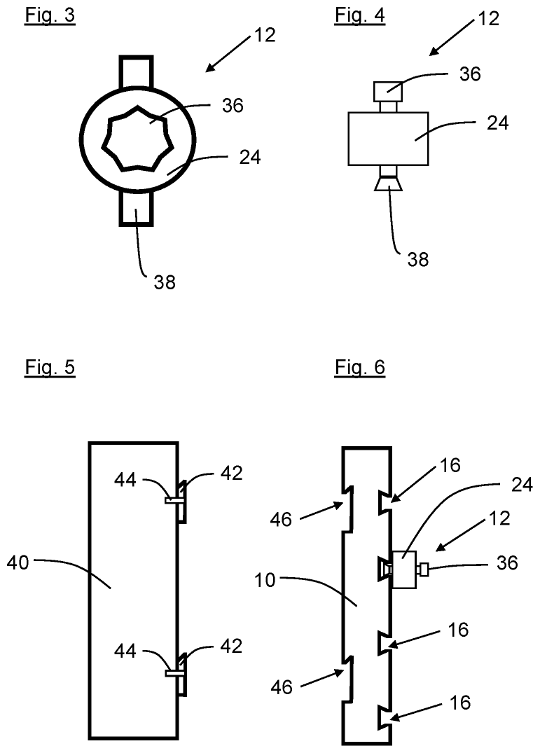

FIG. 3 a plan view of an embodiment of a fastening device of a fastening system as per the invention,

FIG. 4 a side view of the fastening device as per FIG. 3,

FIG. 5 a cross-sectional view of a embodiment design of a wall for fastening a fastening system as per the invention,

FIG. 6 a cross-sectional view of an embodiment of a fastening system as per the invention, and

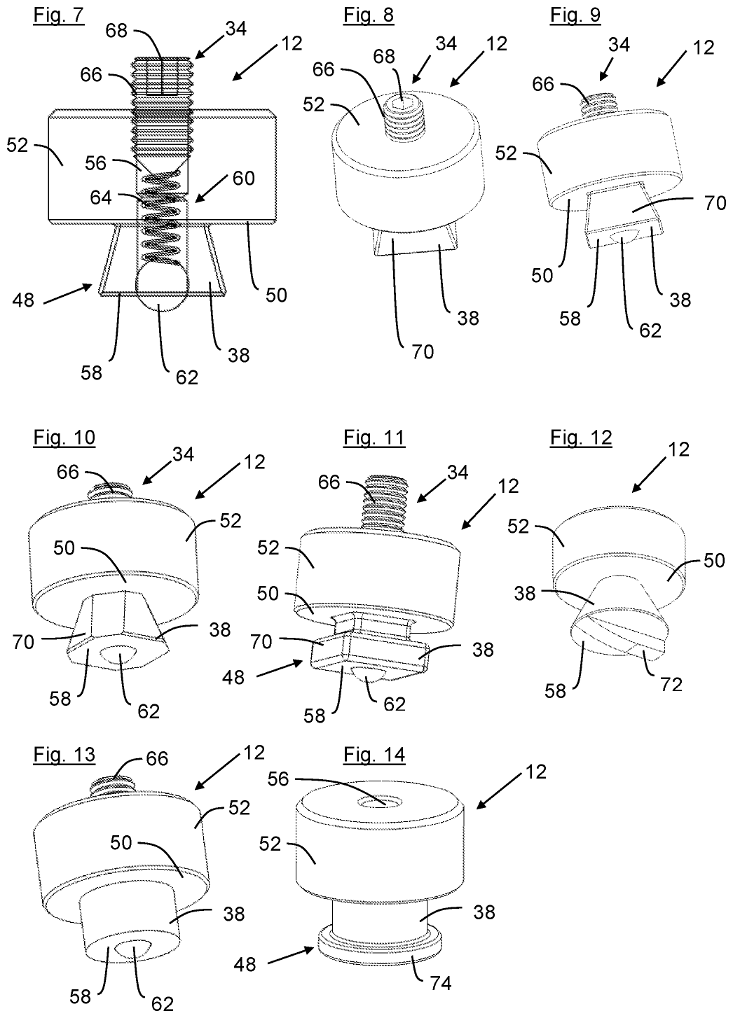

FIG. 7 a cross-sectional view of an embodiment of a fastening device as per the invention, and

FIG. 8 to FIG. 28 perspective views of different embodiments of a fastening device as per the invention.

First of all, it should be noted that the embodiments shown are purely exemplary in nature.

Thus individual features can be realized not only in the shown combination but also alone or in other technically sensible combinations. In particular, the slotted guide or the sliding block can have a different shape. The positions and the number of insertion/removal sections as well as the fastening devices are also purely exemplary. Furthermore, other objects can be fastened to the holder. The features of one embodiment can also be combined with features of another embodiment as desired.

If a figure contains a reference character which is not explained in the directly associated descriptive text, reference is made to the corresponding previous or subsequent deliberations in the figure description. Thus the same reference characters are used for the same or comparable components in the figures and are not explained again.

FIG. 1 shows a fastening system with a planar holder 10 and several fastening devices 12.

The fastening devices 12 are connected to the holder 10 via a slotted guide 14. The holder 10 comprises vertically and horizontally oriented grooves 16. At some points of intersection of the grooves 16, insertion/removal sections 18 are provided, where the fastening devices 12 can be inserted or removed, since at these sections the openings of the grooves 16 are wider than the sliding blocks of the fastening device 12.

The holder 10 can have markings 20. The markings 20 can indicate the position where the fastening devices 12 are to be fastened.

The holder 10 can comprise several holding modules 22, 22′. FIG. 1 shows two holding modules 22, 22′. The connection is symbolized by the dashed line. Depending on the application, any number of holding modules 22, 22′ of any design can be disposed next to each other, especially side by side or one above the other. Preferably the holding modules 22, 22′ can have an identical construction.

The fastening device 12 can be brought into engagement at one of the insertion/removal sections with a vertical or horizontal groove 16 of the holder 10. The fastening device 12 can then be adjusted to the desired position. For this, the fastening device 12 can be moved and detachably fastened in the desired position. The desired position can, for example, be indicated by a marking 20.

An object 24 can then be fastened to a holding device of the fastening device 12. Alternatively, the fastening device 12, already together with the object 24, can also be brought into engagement with the holder 10.

The object 24 can, for example, be an item of sports equipment, such as a pull-up bar 26 or a climbing grip 28. Climbing grips 28 are normally fastened to drive-in nuts disposed in a grid, such that, e.g., the distances between the climbing grips 28 cannot be infinitely adjusted. Repositioning is also comparatively complicated.

However, with the inventive fastening system, the objects can be infinitely adjusted and fastened. In particular, the fastening device can be fastened to the holder without tools.

Changing and/or repositioning the item 24 is thus particularly easy. For example, the height of the pull-up bar 26 can be adapted to the size of a user. Climbing routes, too, for example, can be changed quickly.

As can be seen in the side view in FIG. 2, a roller 30 can, for example, also be fastened to the holder 10 by way of sports device. Also, e.g. a barbell 32 can be connected via a hinged holding device 34 to a fastening device 12 fastened to the holder 10.

In addition, any other objects 24 can be fastened to the desired position as required.

FIG. 3 and FIG. 4 show an example of a fastening device 12, which comprises a screw device 36 with a star grip screw. The screw device 36 is guided through an object 24 and engages with an elongated sliding block 38. The sliding block 38 can have a dovetail-shaped cross-section.

Turning the star grip screw 36 reduces the distance between the screw head and the sliding block 38. In particular, in this connection, a threaded rod is driven into a thread of the sliding block 38.

FIG. 5 shows a wall 40 to which two battens 42 are fastened via dowels 44. Wall 40 can be a conventional wall, e.g. in a fitness studio.

A holder 10 shown in FIG. 6 can be hung onto to this wall 40. For this purpose, the holder 10 has fasteners configured as undercuts 46.

On the side facing away from the wall 10, the holder 10 has grooves 16 for a fastening device 12. The grooves 16 are worked into the panel-shaped holder 10, i.e. they do not protrude, as for example would be the case for metal battens screwed onto the outside. The risk of injury is minimised by this flush closure.

The sliding block 38 of the fastening device 12 can be brought into engagement with a groove 16 at the insertion/removal section. This can then be moved to the desired position and fastened there.

Turning the screw device 36 tightens the fastening device 12 and fastens the object 24 to the holder 10.

FIG. 7 shows a cross-sectional view of a fastening device 12 with a sliding block 38, which has at least one overhang 48. Such a fastening device 12 can, e.g., be used with a fastening system shown in FIG. 1, 2, 5 or 6.

The sliding block 38 extends from a stop surface 50 of a stop body 52. The stop body 52 has a central recess 56. The recess 56 can have an internal thread.

The recess 56 also extends up to an end-face 58 of the sliding block 38. In particular, the recess 56 can taper towards the front.

Disposed in the recess 56 are projection device 60 with a projection member configured, e.g., as a ball 62 and a pre-tensioning device configured, e.g., as a spring 64.

A retaining pin 66 can secure the projection device 60 in the recess 56 and pre-tension the spring 64. Due to the taper of the recess 56, the ball 62 cannot emerge completely in the region of the end-face 58.

The retaining pin 66 can have an external thread. In this way, the retaining pin 66 can be screwed into the internal thread of the recess 56. This can proceed via a tool holder 68, also by means of a tool.

The retaining pin 66 can form part of a holding device 34. Objects 24 can be fastened to the retaining pin 66.

As can be seen in FIGS. 8 and 9, four side-faces 70 extend at an angle in a funnel-shape from the stop surface 50 and thus form the sliding block 38, which can be brought into engagement with a groove 16.

The ball 62 can be adjusted between a fastening position and a displacement position. In the fastening position, a portion of the ball 62 protrudes further beyond the end-face 58 of the sliding block 38 than it does in the displacement position.

In the fastening position, the fastening device 12 is fastened in particular to a groove 16 and cannot move. Displacement of the fastening device is effected by applying a force against the spring force. In this way, the ball 62 is pressed inwards. The self-locking mechanism of the fastening device 12 is released, such that the fastening device 12 can be moved.

FIG. 10 shows a sliding block 38 with eight side-faces 70. This allows a displacement in the x- and y-directions as well as diagonally in addition.

In FIG. 11, the sliding block 38 is T-shaped with four side-faces 70.

FIG. 12 shows a fastening device 12 with a conical sliding block 38. Optionally, a structure 72 can be provided on the end-face 58 as an alternative or in addition to a projection member 62.

Structure 72 could also be shaped differently and, for example, have an undercut.

In particular, structure 72 can cooperate with an correspondingly shaped groove 16. For example, by twisting, preferably through 90 degrees, the fastening device 12 can be fastened to the groove 16.

Structure 72 can be provided alternatively or additionally at groove 16. A correspondingly shaped sliding block 38 can be fastened by turning it, preferably through 90 degrees.

As shown in FIG. 13, the sliding block 38 can be cylindrical.

As shown in FIG. 14, a cylindrical sliding block 38 can have an annular projection 74, which forms an overhang 48.

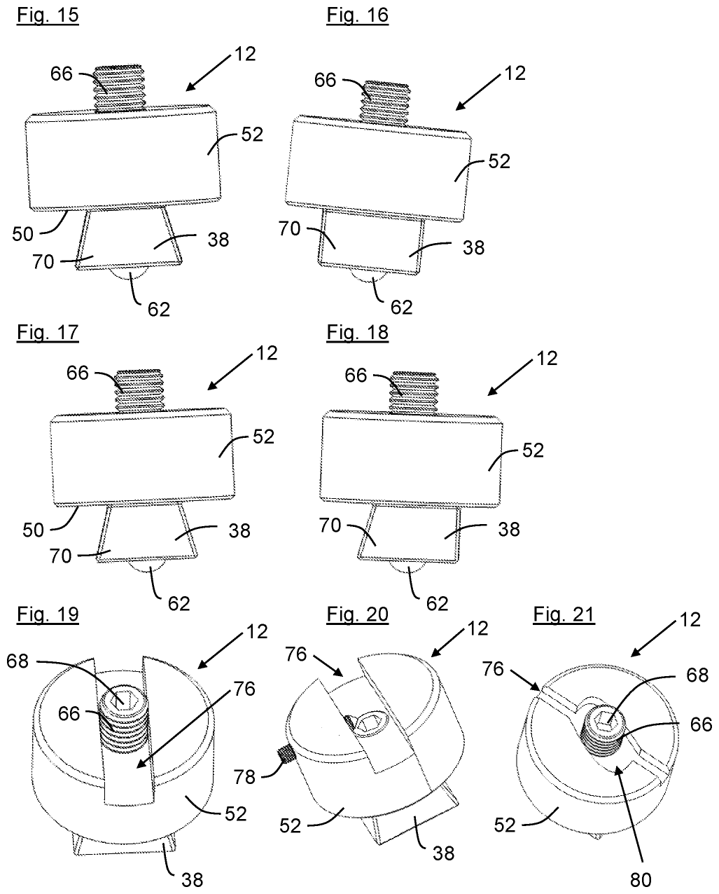

FIGS. 15 and 16 show an embodiment in which two side-faces 70 extend at an angle of 75 degrees and two side-faces 70 extend at an angle of 90 degrees to the stop surface 50.

FIGS. 17 and 18 show an embodiment in which three side-faces 70 extend at an angle of 75 degrees and one side-face 70 extends at an angle of 90 degrees to the stop surface 50.

FIG. 19 shows a fastening device 12 with a holding slot 76 on the end-face facing away from the stop surface 50. The holding slot 76 extends across the entire end-face. An object 24 can be inserted, for example, into the holding slot 76.

As shown in FIG. 20, the holding device 34 has a safety element in the form of a screw 78. An object 24 inserted into the holding slot 76, for example, can thus be fastened.

As shown in FIG. 21, the holding slot 76 can also have an undercut of 80. In the manner of a bayonet lock, an object 24 can be placed on top and turned, for example through 90 degrees. In this way, the object 24 is secured.

The undercut 80 could also, for example, form a structure 72 of a sliding block 38 shown in FIG. 12. In this way, it could be fastened to a groove 16 by twisting.

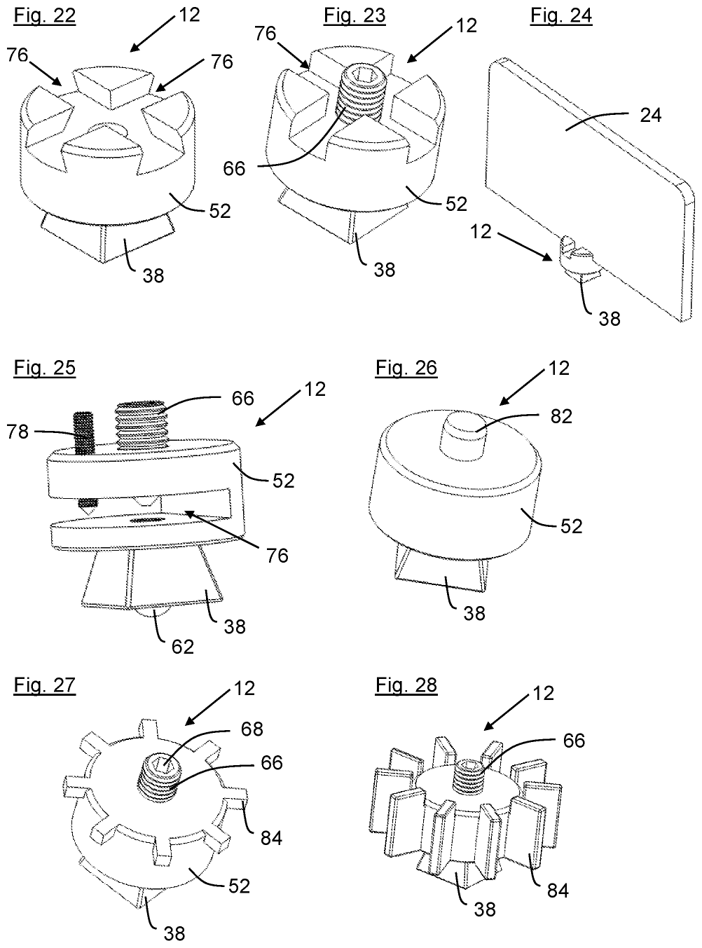

As shown in FIG. 22, two intersecting holding slots 76 can also be provided. The holding slots 76, can be, e.g. dovetail-shaped.

As shown in FIG. 23, the walls of the holding slots 76 can also be straight.

As shown in FIG. 24, an object 24 can be inserted or pushed into the holding slots 76.

According to the embodiment which is shown in FIG. 25, the holding slot 76 can also extend between the upper end-face and the stop surface 50, e.g. as a lateral slot. In this regard, the holding slot 76 is disposed within the stop body 52.

An object 24 can be inserted into the holding slot 76. For example, this can be a panel, e.g. a base panel. The panel can, for example, comprise or consist of a plastic, metal and/or glass material, e.g. sheet metal or Plexiglas.

The panel can be L-shaped, U-shaped or S-shaped. The long limb can be used, e.g., as a supporting surface. A short, lateral limb can be inserted into the holding slot 76 and fastened in it. Depending on the orientation of the fastening device or the shape of the panel, the contact surface can also have a border. For example, the panel can be secured in the fastening device from above or below.

Optionally, the panel can be secured or locked with a screw 78.

As can be seen in FIG. 26, instead of a retaining pin 66 with an external thread, a normal pin 82 can also be provided, which is inserted into the recess 56 of the stop body 52. A catch, for example, can be provided on the pin 82 in order that, for example, an object 24 may be fastened to it.

FIG. 27 shows that the stop body 52 can also have lateral projections 84. The projections 84 in particular can extend in a star-shape. Preferably, the distances between the projections 84 are equal.

As can be seen in FIG. 28, the projections 84 can also extend above the stop surface 50 and/or the end-face facing away from the stop surface 50. Self-locking can thus be improved, as contact with an edge of the groove 16 is established more quickly.

### REFERENCE CHARACTER LIST

10 Holder
12 Fastening device
14 Slotted guide
16 Groove
18 Insertion/removal section
20 Marking
22, 22′ Holding module
24 Object
26 Pull-up bar
28 Climbing grip
30 Roller
32 Barbell
34 Holding device
36 Screw device, star grip screw
38 Sliding block
40 Wall
42 Batten
44 Dowel
46 Undercut, fastening means
48 Overhang
50 Stop surface
52 Stop body
56 Recess
58 End-face
60 Projection device
62 Ball, projection member
64 Spring, pre-tensioning device
66 Retaining pin
68 Tool holder
70 Side-face
72 Structure
74 Projection
76 Holding slot
78 Screw, safety element
80 Undercut
82 Pin
84 Lateral projection

1. System for fastening objects (24), comprising
a holder (10), and
at least one fastening device (12),
wherein the fastening device (12) is connected or can be connected to the holder (10) via a slotted guide (14) and is configured for continuously variable, detachable fastening to the holder (10), wherein
the slotted guide (14) is configured in such a way that the fastening device (12) can be adjusted in at least two dimensions relative to the holder (12).

2. System in accordance with claim 1,
characterised in that
the slotted guide (14) is configured in such a way that the fastening device (12)
can be adjusted in at least one vertical direction and at least one horizontal direction.

3. System in accordance with claim 1,
characterised in that
the slotted guide (14) is configured in such a way that the fastening device (12) can be adjusted in at least one oblique direction.

4. System in accordance with claim 1,
characterised in that
the slotted guide (14) is configured in such a way that the fastening device (12) can be adjusted in at least one curved trajectory.

5. System in accordance with claim 1,
characterised in that
the slotted guide (14) has at least one insertion/removal section (18) into and/or from which the fastening device (12) can be inserted and/or removed.

6. System in accordance with claim 1,
characterised in that
the holder (10) comprises grooves (16) and/or sliding blocks, which are disposed in a grid pattern.

7. System in accordance with claim 6,
characterised in that
insertion/removal sections (18) are provided at points of intersection of the grooves (16).

8. System in accordance with claim 6,
characterised in that
the grooves (16) are T-shaped or dovetail-shaped.

9. System in accordance with claim 1,
characterised in that
the holder (10) is panel-shaped.

10. System in accordance with claim 1,
characterised in that
the holder (10) is modular and comprises several panels that can be disposed next to each other.

11. System in accordance with claim 1,
characterised in that
the holder (10) comprises fastening means (46) for the purpose of fastening to a wall (40), ceiling and/or floor.

12. System in accordance with claim 1,
characterised in that
the fastening device (12) comprises an elongated or round sliding block (38).

13. System in accordance with claim 1,
characterised in that
the fastening device (12) comprises a screwing, locking and/or clamping device (36) for the purpose of fastening to the holder (10).

14. System in accordance with claim 1,
characterised in that
the fastening device (12)
comprises a sliding block (38), which has at least one overhang (48), and
a projection device (60), wherein
the projection device (60) has a projection member (62), which is adjustable between a fastening position and a displacement position, wherein at least a portion of the projection member (62) in the fastening position projects further over the end-face (58) of the sliding block (38) than in the displacement position.

15. System in accordance with claim 1,
characterised in that
the fastening device (12) comprises a holding device (34) for an object (24), in particular an item of sports equipment (26, 28, 30, 32) and/or a medical device and/or
a marking (20) is provided to indicate a fastening point for the fastening device (12).

16. System in accordance with claim 7,
characterised in that
each point of intersection has an insertion/removal section (18).

17. System in accordance with claim 12,
characterised in that
the sliding block (38) is T-shaped or dovetail-shaped.

18. System in accordance with claim 14,
characterised in that
the projection device (60) has a pre-tensioning device (64), which pre-tensions the projection member (62) into the fastening position.
